(19) United States
(12) Patent Application Publication
(10) Pub. No.: US 2009/0067008 A1
(43) Pub. Date: Mar. 12, 2009

(54) SYSTEM AND METHOD FOR TRANSPORTABLE SOFTWARE OPERATION OF DOCUMENT PROCESSING DEVICES

(76) Inventors: Marianne L. Kodimer, Huntington Beach, CA (US); Silvy J. Wilson, Rancho Santa Margarita, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,168

(22) Filed: Sep. 6, 2007

(51) Int. Cl. H04N 1/00

(52) U.S. Cl. 358/402

(57) ABSTRACT

The subject application is directed to a system and method for transportable software operation of document processing devices. A portable data storage device is first received, whereupon a bi-directional data communication link is established with the portable data storage device. Operational data associated with the operation of a document processing device is then communicated from the portable data storage device. Operation of the document processing device is then commenced in concert with the operational data received from the portable data storage device. The operation of the document processing device is terminated upon removal of the portable data storage device.

### BACKGROUND OF THE INVENTION

The subject application is directed generally to secure or custom operation or control of document processing devices. The application is more particularly applicable to a system and method wherein individual users are able to transport non-volatile memory devices to document processing devices to allow for customized operation, data acquisition, or customized interfaces in a secure fashion.

Current document processing devices include copiers, printers, facsimile machines, electronic mail devices, storage areas, and the like. Devices which accomplish one or more of these functions are often referred to as multi-function peripherals or MFPs.

Document processing devices typically include an associated controller, which controller is an intelligent computer system that accomplishes control and operation of one or more device operations. An advantage of using a controller is that it affords flexibility and adaptability to operation of a document processing device. A controller is also advantageously used to generate a user interface associated with use of a device. A user interface may be associated with the device, such as an LCD display on a MFP, or it may be via a remote computer. Interface with a remote computer is available via wired or wireless connection, such as with a direct connection or via a network. Connections with remote systems may be accomplished, typically via controller interaction, via a thin client such as a web interface, or a thick client such as a print driver, disposed on the remote system.

Operation of a controller, or an associated document processing device, requires appropriate executable code, appropriate non-executable data, and results in status information being generated. In a shared peripheral environment, certain operations may be restricted to selected users, and certain data may be sensitive and viewing or retrieval should be restricted. In addition, users are typically relegated to use of standardized user interfaces, particularly in connection with integrated displays like a MFP touch screen.

### SUMMARY OF THE INVENTION

In accordance with one embodiment of the subject application, there is provided a system and method for secure operation or control of a document processing device.

Further, in accordance with one embodiment of the subject application, there is provided a system and method for custom operation or control of a document processing device.

Still further, in accordance with one embodiment of the subject application, there is provided a system and method wherein individual users are able to transport non-volatile memory devices to document processing devices to allow for customized operation, data acquisition, or customized interfaces in a secure fashion.

Further, in accordance with one embodiment of the subject application, there is provided a transportable software operation system for document processing devices. The system comprises receiving means adapted for receiving an associated, portable data storage and means adapted for establishing a bi-directional data communication link with a received portable data storage. The system also comprises means adapted for communicating operational data associated with operation of a document processing device with a received portable data storage such that operation of the document processing device is accomplished in concert with operational data communicated with the portable data storage. The system further includes means adapted for terminating operation of the document processing device in accordance with communicated operational data upon removal of the received portable data storage from the receiving means.

In one embodiment of the subject application, the operational data includes executable code adapted for operating on a controller associated with the document processing device. In another embodiment of the subject application, the operational data includes code adapted to generate, on a display associated with the document processing device, a customized user interface.

In yet another embodiment of the subject application, the operational date includes status data associated with a status of operation of the document processing device.

In a further embodiment of the subject application, the system further comprises means adapted for receiving an electronic document from a received portable data storage via the bi-directional data link. In such embodiment, the document processing device operates on received electronic document data in connection with communicated operational data.

In still another embodiment of the subject application, the portable data storage is selected from a set consisting of flash memory, CD, DVD, and portable hard disk.

In accordance with one embodiment of the subject application, the bi-directional data communication link is a wireless data connection.

Still further, in accordance with one embodiment of the subject application, there is provided a method for transportable software operation of document processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a transportable software operation system for document processing devices according to one embodiment of the subject application;

FIG. 2 is a block diagram illustrating device hardware for use in the transportable software operation system for document processing devices according to one embodiment of the subject application;

FIG. 3 is a functional diagram illustrating the device for use in the transportable software operation system for document processing devices according to one embodiment of the subject application;

FIG. 4 is a block diagram illustrating controller hardware for use in the transportable software operation system for document processing devices according to one embodiment of the subject application;

FIG. 5 is a functional diagram illustrating the controller for use in the transportable software operation system for document processing devices according to one embodiment of the subject application;

FIG. 6 is a flowchart illustrating a transportable software operation method for document processing devices according to one embodiment of the subject application; and

FIG. 7 is a flowchart illustrating a transportable software operation method for document processing devices according to one embodiment of the subject application.

### DETAILED DESCRIPTION OF THE PREFERRED EMBODIMENT

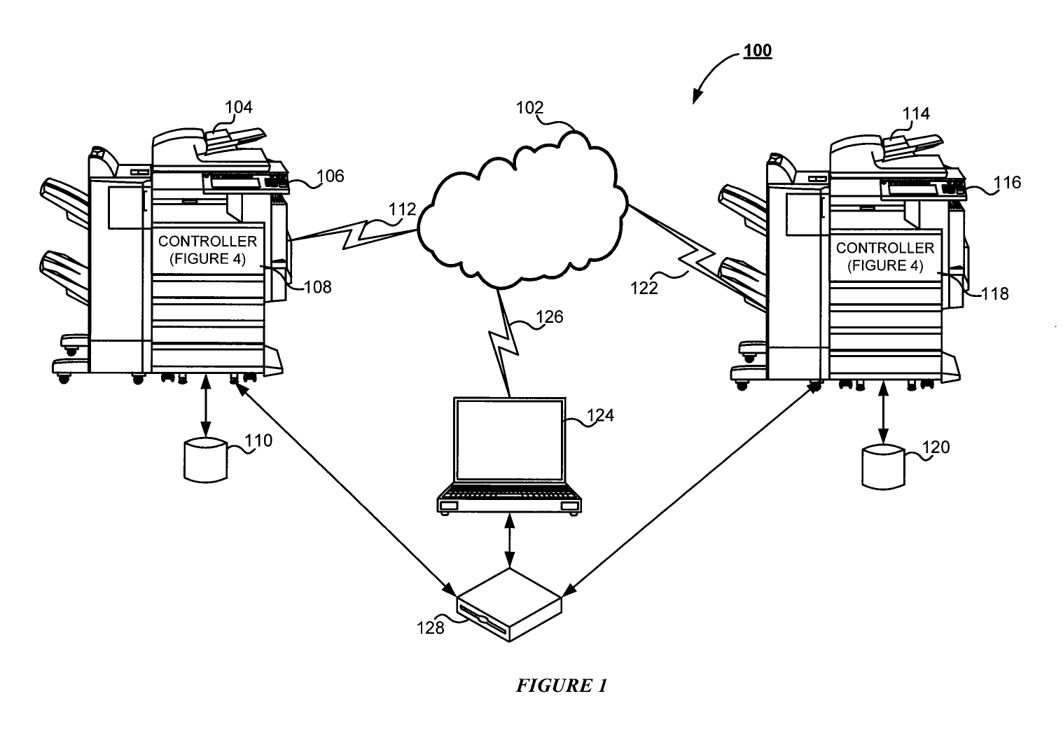

The subject application is directed to a system and method for secure operation or control of a document processing device. In particular, the subject application is directed to a system and method for custom operation or control of a document processing device. More particularly, the subject application is directed to a system and method wherein individual users are able to transport non-volatile memory devices to document processing devices to allow for customized operation, data acquisition, or customized interfaces in a secure fashion. It will become apparent to those skilled in the art that the system and method described herein are suitably adapted to a plurality of varying electronic fields employing portable data storage, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a transportable software operation system 100 for document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

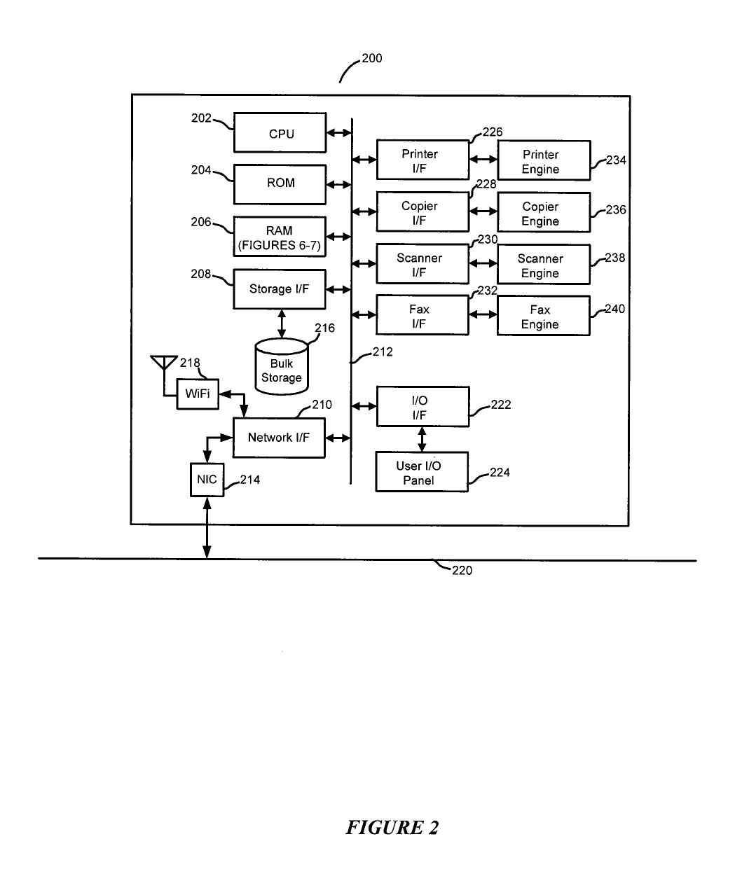

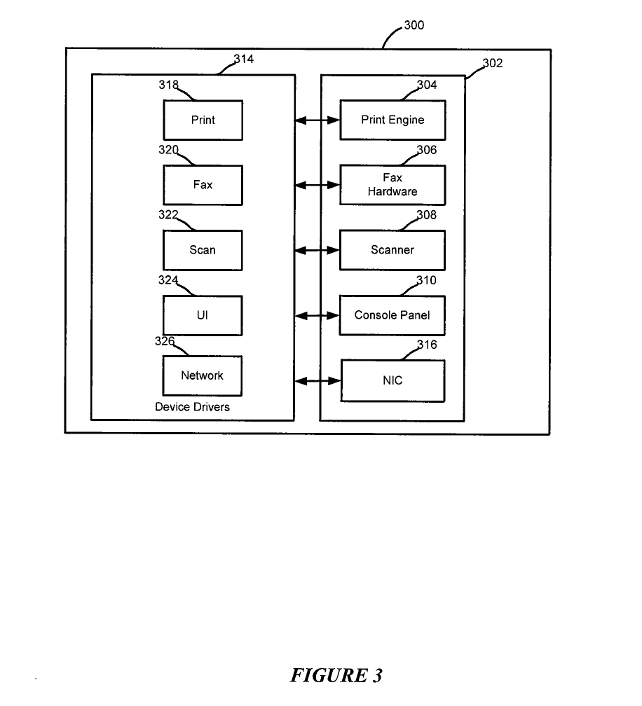

The system 100 also includes a first document processing device 104 and a second document processing device 114, depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the first document processing device 104 and the second document processing device 114 are suitably adapted to provide remote document processing services to external or network devices. Preferably, the document processing devices 104 and 114 include hardware, software, and any suitable combination thereof, configured to interact with an associated user, a networked device, or the like. The functioning of the document processing devices 104 and 114 will better be understood in conjunction with the block diagrams illustrated in FIGS. 2 and 3, explained in greater detail below.

According to one embodiment of the subject application, the first document processing device 104 and the second document processing device 114 are suitably equipped to receive a plurality of portable storage media 128, including, without limitation, Firewire drive, USB drive, SD, MMC, XD, Compact Flash, Memory Stick, CD, DVD, portable hard disk drive, and the like. In accordance with a further embodiment of the subject application, the portable data storage device 128 is capable of being connected to the associated document processing device 104 via a wired connection, e.g., USB, IEEE 1394, SATA, serial, parallel, card reader, or the like, or a wireless connection, i.e., BLUETOOTH, infrared, radio frequency, or the like. The portable storage media is suitably capable of including, for example and without limitation, software upgrades, executable files, extended workflow capabilities, diagnostic capture capability, portable personal graphical user interface settings, templates, preferences, scanned data, stored document data, configuration data, or the like. In accordance with one embodiment of the subject application, the portable storage device is readily detectable by the associated document processing device 104 or 114, such as, for example and without limitation, a plug-and-play device.

In the preferred embodiment of the subject application, the first document processing device 104 and the second document processing device 114 each further include an associated user interface 106 and 116, such as a touch-screen, LCD display, touch-panel, alpha-numeric keypad, or the like, via which an associated user is able to interact directly with the corresponding document processing device 104 and 114. In accordance with the preferred embodiment of the subject application, the user interfaces 106 and 116 are advantageously used to communicate information to the associated user and receive selections from the associated user. The skilled artisan will appreciate that the user interfaces 106 and 116 comprise various components, suitably adapted to present data to the associated user, as are known in the art. In accordance with one embodiment of the subject application, each of the user interfaces 106 and 116 comprise a display, suitably adapted to display one or more graphical elements, text data, images, or the like, to an associated user, receive input from the associated user, and communicate the same to a backend component, such as a corresponding controller 108 or 118, as explained in greater detail below. Preferably, the first document processing device 104 is communicatively coupled to the computer network 102 via a suitable communications link 112 and the second document processing device 114 is communicatively coupled to the computer network 102 via a suitable communications link 122. As will be understood by those skilled in the art, suitable communications links include, for example and without limitation, WiMax, 802.11a, 802.11b, 802.11g, 802.11(x), BLUETOOTH, the public switched telephone network, a proprietary communications network, infrared, optical, or any other suitable wired or wireless data transmission communications known in the art.

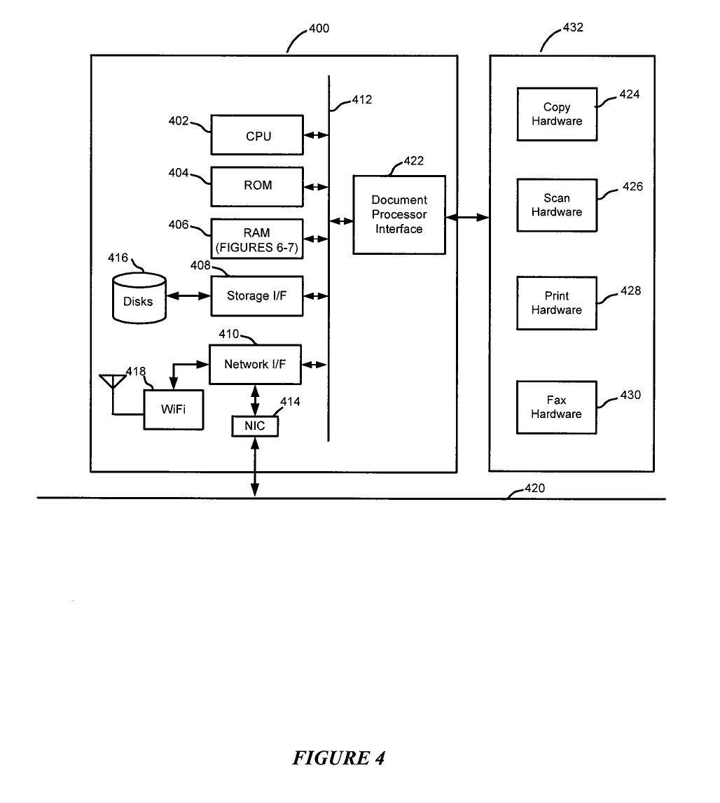

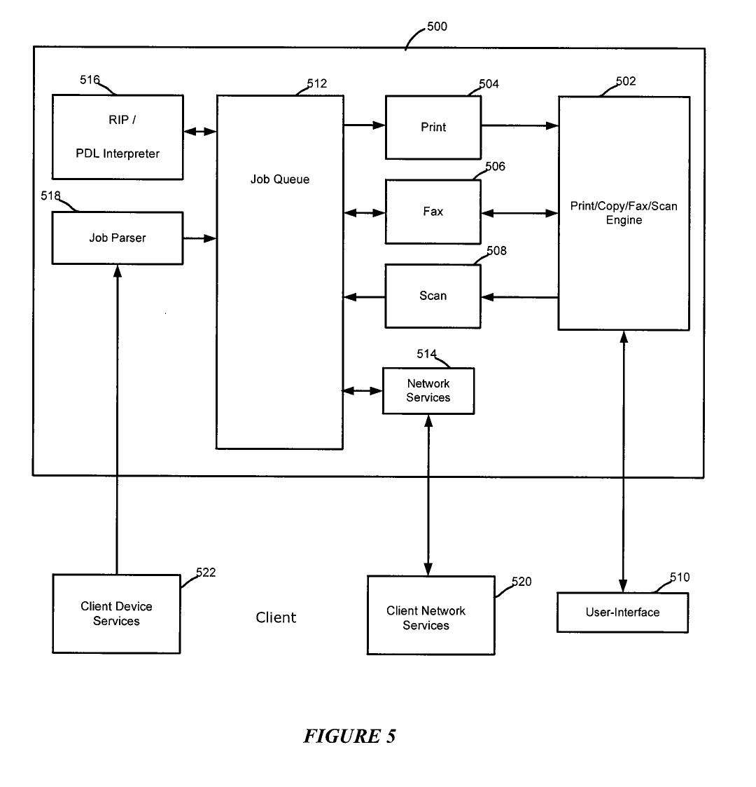

In accordance with one embodiment of the subject application, the first document processing device 104 and the second document processing device 114 further incorporate a backend component, designated as the controllers 108 and 118, suitably adapted to facilitate the operations of the first document processing device 104 and the second document processing device 114, respectively, as will be understood by those skilled in the art. Preferably, the controllers 108 and 118 are embodied as hardware, software, or any suitable combination thereof, configured to control the operations of the associated document processing devices 104 and 114, facilitate the display of images via the user interfaces 106 and 116, direct the manipulation of electronic image data, and the like. For purposes of explanation, the controllers 108 and 118 are used to refer to any of a myriad of components associated with the document processing devices 104 and 114, including hardware, software, or combinations thereof, functioning to perform, cause to be performed, control, or otherwise direct the methodologies described hereinafter. It will be understood by those skilled in the art that the methodologies described with respect to the controllers 108 and 118 are capable of being performed by any general purpose computing system, known in the art, and thus the controllers 108 and 118 are representative of such general computing devices and is intended as such when used hereinafter. Furthermore, the use of the controllers 108 and 118 hereinafter is for the example embodiment only, and other embodiments, which will be apparent to one skilled in the art, are capable of employing the system and method for transportable software operation of document processing devices of the subject application. The functioning of the controllers 108 and 118 will better be understood in conjunction with the block diagrams illustrated in FIGS. 4 and 5, explained in greater detail below.

Communicatively coupled to the document processing devices 104 and 114 are corresponding data storage devices 110 and 120. In accordance with the preferred embodiment of the subject application, the data storage devices 110 and 120 are any mass storage device known in the art including, for example and without limitation, magnetic storage drives, a hard disk drive, optical storage devices, flash memory devices, or any suitable combination thereof. In the preferred embodiment, the data storage devices 110 and 120 are suitably adapted to store document data, image data, electronic database data, or the like. It will be appreciated by those skilled in the art that while illustrated in FIG. 1 as being a separate component of the system 100, the data storage devices 110 and 120 are capable of being implemented as internal storage component of the corresponding document processing devices 104 and 114, a component of the controllers 108 and 118, or the like, such as, for example and without limitation, an internal hard disk drive, or the like.

The system 100 illustrated in FIG. 1 further depicts a user device 124, in data communication with the computer network 102 via a communications link 126. It will be appreciated by those skilled in the art that the user device 124 is shown in FIG. 1 as a laptop computer for illustration purposes only. As will be understood by those skilled in the art, the user device 124 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 126 is any suitable channel of data communications known in the art including, but not limited to wireless communications, for example and without limitation, BLUETOOTH, WiMax, 802.11a, 802.11b, 802.11g, 802.11(x), a proprietary communications network, infrared, optical, the public switched telephone network, or any suitable wireless data transmission system, or wired communications known in the art. Preferably, the user device 124 is suitably adapted to generate and transmit electronic documents, document processing instructions, user interface modifications, upgrades, updates, personalization data, or the like, to the document processing devices 104 and 114, or any other similar device coupled to the computer network 102.

Turning now to FIG. 2, illustrated is a representative architecture of a suitable device 200, (shown in FIG. 1 as the first document processing device 104 and the second document processing device 114), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the first document processing device 104 and the second document processing device 114), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108 and 118, on which operations of the subject system 100 are completed. The skilled artisan will understand that the controllers 108 and 118 are representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104, 114, which include the controller 400 of FIG. 4, (shown in FIG. 1 as the controllers 108 and 118) as an intelligent subsystem associated with a corresponding document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, a portable data storage device is first received, whereupon a bi-directional data communication link is established with the portable data storage device. Operational data associated with the operation of a document processing device is then communicated from the portable data storage device. Operation of the document processing device is then commenced in concert with the operational data received from the portable data storage device. Upon removal of the portable data storage device, the operation of the document processing device is terminated.

In accordance with one example embodiment of the subject application, a portable data storage device 128, such as, for example and without limitation, flash memory, portable hard disk drive, CD, DVD, or the like, is received by the first document processing device 104, the second document processing device 114, or the user device 124. It will be appreciated by those skilled in the art that the receipt of the portable data storage device 128 is capable of being accomplished via insertion of the device 128 into a corresponding storage reading component associated with the first document processing device 104, the second document processing device 114, the user device 124, or the like. In accordance with one embodiment of the subject application, the receipt of the portable data storage device 128 by the associated document processing device 104 is capable of being accomplished via a wired connection, e.g., USB, IEEE 1394, SATA, serial, parallel, card reader, or the like, or a wireless connection, i.e., BLUETOOTH, infrared, radio frequency, or the like. Upon receipt of the portable data storage device 128, a graphical user interface is generated via a corresponding display associated with the receiving device, e.g., the user interface 106 of the first document processing device 104, the user interface 116 of the second document processing device 114, a display of the user device 124, or the like.

The recipient device or a suitable component thereof, e.g., the controller 108 of the first document processing device 104, the controller 118 of the second document processing device 114, the user device 124, or the like, then detects any data stored on the portable storage device 128. The user is then prompted via the graphical user interface to select an import action or an export action. As will be understood by those skilled in the art, such an import action includes, for example and without limitation, transferring data from the portable storage device 128 to the data storage device 110, the data storage device 120, a hard disk drive of the user device 124, system memory of the controller 108 or 118, or the like. The skilled artisan will appreciate that a suitable export action includes, for example and without limitation, transferring data to the portable data storage device 128 from the data storage device 110 or 120, the user device 124, system memory of the document processing devices 104 or 114, or the like.

When the user selects an export action, the user is then prompted, via the graphical user interface generated on the user interface 106 or 116 of the receiving document processing device 104 or 114, respectively, via the user device 124, or the like, to select data to be transferred to the portable data storage device 128. In accordance with one embodiment of the subject application, suitable data to be transferred to the portable data storage device 128 includes, for example and without limitation, document data, image data, operational data, configuration data, customized interface data, user preference data, executable code, or the like. The selected data is then stored on the portable data storage device 128. Upon removal of the portable data storage device 128 from the recipient device 104, 114, or 124, any operational data communicated from the portable data storage device 128, as discussed in greater detail below, is deleted from the recipient device 104, 114, or 124. In the event that further actions are desired by the user with respect to the portable data storage device 128, the graphical user interface prompts the user to select an import action or an export action.

When the user selects an import action, the controller 108 associated with the first document processing device 104, the controller 118 associated with the second document processing device 114, or the user device 124, depending upon at which device the portable data storage device 128 has been received, retrieves the data stored on the portable data storage device 128. The retrieved data is then displayed to an associated user via the user interface 106, the user interface 116, the user device 124, or the like. Selection of data is then received from the user and a determination is made whether the selected data corresponds to operational data. That is, whether the data selected by the user for import by the recipient device corresponds to operation commands, preferences, executable code, or the like, to configure, modify, or be otherwise implemented by the recipient device. In accordance with one embodiment of the subject application, such operational data includes, for example and without limitation, software upgrades, extension of workflow capabilities, diagnostic or status capture applications, personalized graphical user interface data, scripts, software applications, or the like.

Upon a determination that the selected data for import is operational data, the operational data is transferred from the portable data storage device 128 to the recipient device 104, 114, 124, whereupon operations of the recipient device 104, 114, or 124 are commenced in accordance with the received operational data. For example, when the operational data corresponds to a customized document processing workflow, the receiving document processing device 104 or 114 implements or executes such a workflow, thereby enabling the user to perform a document processing operation in accordance with the customized workflow from the portable data storage device 128. The operational data, such as user preferences, workflows, configurations, or the like, thereafter remains accessible to the user until the portable data storage device 128 is removed from the receiving device. Upon removal of the portable data storage device 128, the operational data is securely deleted from the receiving device 104, 114, or 124, as will be understood by those skilled in the art.

When the data selected by the user from the portable data storage device 128 does not correspond to operational data, the user is prompted, via the graphical user interface, to select a corresponding operation to be performed on the data. For example, when the receiving device is a document processing device 104 or 114, and the data selected is a document or image, the user is prompted to select a corresponding document processing operation. Thereafter, the document processing device 104 or 114 performs the selected document processing operation on the selected data. A determination is then made whether the user desires to perform another action with respect to data stored on the portable data storage device 128. When additional actions are desired, the user selects the desired action, i.e., import or export, via the graphical user interface and operations continue thereon. When no additional actions are desired, or upon removal of the portable data storage device 128, any operational data transferred from the portable data storage device 128 to a recipient device 104, 114, or 124, is securely deleted from the recipient device 104, 114, or 124.

Thus, in accordance with the example embodiment above, a user connects a portable data storage device 128 into the first document processing device 104. Via interactions with the graphical user interface, the user selects a customized application for gathering status data of a document processing device to be transferred to the portable data storage device 128. The application is then stored on the portable data storage device 128. The user then inserts the portable data storage device 128 in the appropriate interface of the second document processing device 114. The controller 118 associated with the second document processing device 114 then detects the portable data storage device 128 and via the user interface 116, prompts the user to import or export data with respect to the received portable data storage device 128. When an import action is selected by the user, the controller 118 accesses the portable data storage device 128 and retrieves data files stored thereon. The retrieved files are then displayed to the user via the user interface 116 for user selection. Upon selection by the user of the status application, the controller 118 facilitates the transfer of the application from the portable data storage device 128 to the data storage device 120, system memory, or the like, associated with the second document processing device 114. The controller 118 then executes the application, thereafter commencing monitoring operations in accordance with the application. Upon removal of the portable data storage device 128 from the second document processing device 114, the status application is deleted from the data storage device 120, system memory, or the like. It will therefore be apparent to those skilled in the art that the subject application enables the use of the portable data storage device 128 to provide additional features and functionalities to associated document processing devices, as set forth above in the example embodiment.

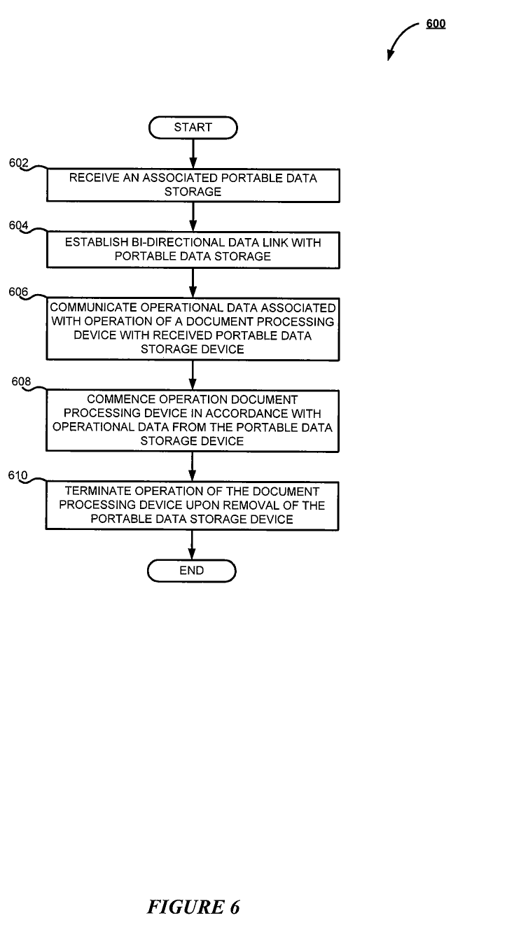

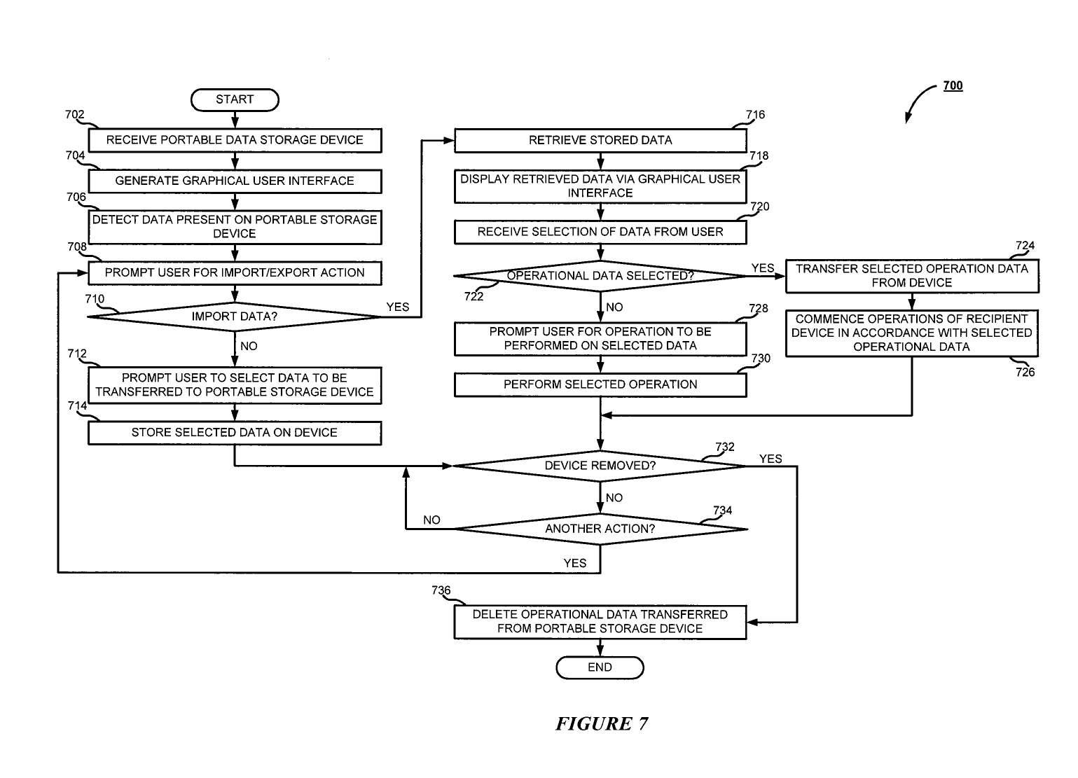

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for transportable software operation of document processing devices in accordance with one embodiment of the subject application. Beginning at step 602, an associated portable data storage is received by an associated document processing device, for example, the first document processing device 104. For purposes of example, only, reference is made hereinafter to the first document processing device 104 as a recipient device. In accordance with such an example, operational data, such as, for example and without limitation, software upgrades, improved workflow capabilities, personalized graphical user interface data, diagnostic data retrieval applications, or the like, are capable of being previously transferred to the portable data storage device 128 from connection, either wired or wirelessly, with the user device 124 or any other suitable device. Suitable examples of the portable data storage device 128 include, for example and without limitation, flash memory, CD, DVD, portable hard disk drive, and the like.

At step 604, a bi-directional data is established between the first document processing device 104 and the portable data storage device 128. As will be appreciated by those skilled in the art, such bi-directional data communications link is capable of including, for example and without limitation, a wired communications link, such as via USB, IEEE 1394, flash card interface, or the like, or a wireless communications link. At step 606, operations of the document processing device 104 are commenced in accordance with the operational data retrieved from the portable data storage device 128 via the bi-directional communications link. The commenced operation of the document processing device 104 is then terminated upon removal of the portable data storage device 128 from the document processing device 104.

Referring now to FIG. 7, there is shown a flowchart 700 illustrating a method for transportable software operation of document processing devices in accordance with one embodiment of the subject application. The method depicted in FIG. 7 begins at step 702, whereupon a portable data storage device 128 is received by an associated device, for example purposes only, the document processing device 104. In accordance with one embodiment of the subject application, suitable examples of a portable data storage device 128 include, for example and without limitation, flash memory, such as xD, secure digital, memory stick, compact flash, smart media, or the like, USB drives, portable hard disk drives, CD, DVD, or the like. In accordance with a further embodiment of the subject application, the receipt of the portable data storage device 128 by the associated document processing device 104 is capable of being accomplished via a wired connection, e.g., USB, IEEE 1394, SATA, serial, parallel, card reader, or the like, or a wireless connection, i.e., BLUETOOTH, infrared, radio frequency, or the like. A graphical user interface facilitating the interaction between an associated user and the document processing device 104 is then generated via the user interface 106 at step 704. The data, if any, present on the received portable data storage device 128, is then detected by the controller 108 or other suitable component of the document processing device 104 at step 706. Thereafter, the user is prompted, via the graphical user interface 106, to select an import action or an export action at step 708. That is, the user is prompted to either transfer data to the portable data storage device 128 (export action) or transfer data from the portable data storage device 128 to the document processing device 104 (import action).

A determination is then made at step 710 whether the user has selected an import action. When the user has selected to export data from the document processing device 104 to the portable data storage device 128, flow proceeds to step 712, whereupon the user is prompted, via the graphical user interface, to select the data to be transferred to the portable data storage device 128. As will be appreciated by those skilled in the art, suitable data includes, for example and without limitation document data, image data, or the like. The skilled artisan will further appreciate that in accordance with a further embodiment of the subject application, the selected data is capable of comprising operational data that includes, for example and without limitation, customized workflow data, i.e., a series of operations to be performed by an associated document processing device so as to output a processed document, customized user interface data, i.e., a user home page or the like that is implemented via the user interface of an associated document processing device, a status application, i.e., a program executable by an associated document processing device to retrieve document processing device status data, functionality extension applications, i.e., software programs to add additional features or functionalities to an associated document processing device, upgrades, configuration data, user preferences, or the like. The selected data is then transferred to the portable data storage device 128 at step 714, whereupon flow proceeds to step 732.

A determination is then made at step 732 whether the portable data storage device 128 has been removed. Upon removal of the device any operational data that was transferred from the portable data storage device 128 to the document processing device 104 is deleted at step 736 and the operation with respect to the first document processing device 104 terminates. When the portable data storage device 128 is not removed, flow proceeds to step 734, whereupon a determination is made whether another action is desired, or has been selected, by the user, i.e., whether the user has selected an import or export action. When no additional action is desired by the user, flow returns to step 732, awaiting the removal of the portable data storage device 128. When an additional action is desired by the user, flow returns from step 734 to step 708 and operations continue as set forth above. The skilled artisan will therefore appreciate that the operational data stored on the portable data storage device 128 enables the transfer of such applications, programs, and the like, from the first document processing device 104 and the second document processing device 114. Thus a user is able to transfer workflows, customized preferences, and the like, from one device to another, as explained in greater detail below.

Returning to step 710, when it is determined that the action is an import action, flow proceeds from step 710 to step 716, whereupon the data stored on the portable data storage device 128 is retrieved by the controller 108 or other suitable component associated with the document processing device 104. The retrieved data is then displayed, via the graphical user interface on the user interface 106 of the document processing device 104 at step 718. At step 720, the controller 108 or other suitable component associated with the document processing device 104 receives user selection of data via the graphical user interface displayed on the user interface 106. A determination is then made at step 722 whether the user has selected operational data. That is, whether the user has selected executable code, scripts, configuration files, or the like, on the portable data storage device 128 that are capable of being executed by the document processing device 104, resulting in additional applications, functions, customizations, and the like, becoming available to the user via the receiving document processing device 104. When operational data has been selected, flow proceeds to step 724, whereupon the operational data is transferred from the portable data storage device 128 to the document processing device 104. As will be appreciated by those skilled in the art, the operational data is capable of being transferred directly into system memory of the controller 108, transferred to the data storage device 110, or the like. Those resources, applications, or functions affected by the operational data are then restarted in accordance with the operational data by the controller 108 and operations of the document processing device 104 are commenced at step 726. Operations then proceed to step 732 as set forth above.

Returning to step 722, when the data selected by the user is not operational data, flow proceeds to step 728, whereupon the user is prompted for a document processing operation to be performed by the document processing device 104 on the selected data. Following user selection of a desired operation, flow proceeds to step 730, whereat the document processing device 104 performs the selected document processing operation. A determination is then made at step 732 whether the portable data storage device 128 has been removed from the document processing device 104. When the portable data storage device 128 has been removed, operational data transferred to the document processing device 104 is securely erased from memory at step 736. When the portable data storage device 128 has not been removed, a determination is made at step 734 whether another action, e.g., import data from the device 128 or export data to the device 128, is desired by the user. When additional actions are desired, flow returns to prompting the user to select a desired action at step 708. When no additional actions are desired, flow returns to step 732, whereupon the controller 108 associated with the document processing device 104 awaits the removal of the portable data storage device 128 or the selection of another action.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A transportable software operation system for document processing devices comprising:
receiving means adapted for receiving an associated, portable data storage;
means adapted for establishing a bi-directional data communication link with a received portable data storage;
means adapted for communicating operational data associated with operation of a document processing device with a received portable data storage such that operation of the document processing device is accomplished in concert with operational data communicated with the portable data storage; and
means adapted for terminating operation of the document processing device in accordance with communicated operational data upon removal of the received portable data storage from the receiving means.

2. The system of claim 1 wherein the operational data includes executable code adapted for operating on a controller associated with the document processing device.

3. The system of claim 1 wherein the operational data includes code adapted to generate, on a display associated with the document processing device, a customized user interface.

4. The system of claim 1 wherein the operational date includes status data associated with a status of operation of the document processing device.

5. The system of claim 1 further comprising:
means adapted for receiving an electronic document from a received portable data storage via the bi-directional data link; and
wherein the document processing device operates on received electronic document data in connection with communicated operational data.

6. The system of claim 1 wherein the portable data storage is selected from a set consisting of flash memory, CD, DVD, and portable hard disk.

7. The system of claim 1 wherein the bi-directional data communication link is a wireless data connection.

8. A transportable software operation method for document processing devices comprising the steps of:
receiving an associated, portable data storage;
establishing a bi-directional data communication link with a received portable data storage;
communicating operational data associated with operation of a document processing device with a received portable data storage such that operation of the document processing device is accomplished in concert with operational data communicated with the portable data storage; and
terminating operation of the document processing device in accordance with communicated operational data upon removal of the received portable data storage.

9. The method of claim 8 wherein the operational data includes executable code adapted for operating on a controller associated with the document processing device.

10. The method of claim 8 wherein the operational data includes code adapted to generate, on a display associated with the document processing device, a customized user interface.

11. The method of claim 8 wherein the operational date includes status data associated with a status of operation of the document processing device.

12. The method of claim 8 further comprising the steps of:
receiving an electronic document from a received portable data storage via the bi-directional data link; and
commencing operation on received electronic document data, via the document processing device, in connection with communicated operational data.

13. The method of claim 8 wherein the portable data storage is selected from a set consisting of flash memory, CD, DVD, and portable hard disk.

14. The method of claim 8 wherein the bi-directional data communication link is a wireless data connection.

15. A computer-implemented method for transportable software operation of document processing devices comprising the steps of:
receiving an associated, portable data storage;
establishing a bi-directional data communication link with a received portable data storage;
communicating operational data associated with operation of a document processing device with a received portable data storage such that operation of the document processing device is accomplished in concert with operational data communicated with the portable data storage; and
terminating operation of the document processing device in accordance with communicated operational data upon removal of the received portable data storage.

16. The computer-implemented method of claim 15 wherein the operational data includes executable code adapted for operating on a controller associated with the document processing device.

17. The computer-implemented method of claim 15 wherein the operational data includes code adapted to generate, on a display associated with the document processing device, a customized user interface.

18. The computer-implemented method of claim 15 wherein the operational date includes status data associated with a status of operation of the document processing device.

19. The computer-implemented method of claim 15 further comprising the steps of:
receiving an electronic document from a received portable data storage via the bi-directional data link; and
commencing operation on received electronic document data, via the document processing device, in connection with communicated operational data.

20. The computer-implemented method of claim 15 wherein the bi-directional data communication link is a wireless data connection.
